(19) United States
(12) Patent Application Publication
(10) Pub. No.: US 2002/0186625 A1
(43) Pub. Date: Dec. 12, 2002

(54) Method of rapidly adjusting optical drive focus error level

(76) Inventors: Chien-Li Hung, Taipei (TW); Chi-Yuan Liu, Taipei (TW); Yao-Chou Tsai, Taipei (TW)

Correspondence Address: Chien-Wei (Chris) Chou, Esq., OPPENHEIMER WOLFF & DONNELLY LLP, Suite 300, 101 Park Center Plaza, San Jose, CA, 95113, US

(21) Appl. No.: 09/994,426

(22) Filed: Nov. 26, 2001

(30) Foreign Application Priority Data
Jun. 8, 2001 (TW) 90113947

(51) Int. Cl. G11B 7/095

(52) U.S. Cl. 369/44.29

(57) ABSTRACT

The present invention discloses a method of rapidly adjusting optical drive focus error signal level. First, select a referral focus error level. Then, sink the object lens to the bottom, and start moving the object lens in a direction of the disk. Then, detect the focus error level and determine a position of the focal point of the object lens; when a difference between the focus error level and the referral focus error level is beyond an error tolerance, calculate the gain of the pre-amp to be adjusted, and change the moving direction of the object lens, and repeat the aforementioned adjusting process

### BACKGROUND OF THE INVENTION

1. Field of the Invention

The invention relates to a method of rapidly adjusting optical drive focus error level, and particularly to a method of signal adjustment by detecting the focus point and moving the object lens upward and downward near the focus point, so as to adjust the focus error level efficiently.

2. Description of the Related Art

Generally, an optical head of an optical drive, such as a CD-ROM, in reading is shown in FIG. 1. The optical head produces a laser beam from a laser diode 11a, and the laser beam goes through a beam splitter 12a and an object lens 13a to focus at a focus point 14a. The object lens 13a is moved upward and downward by a focus actuator 15a for changing the position of the focus point 14a; if the focus point 14a falls on the disk 16a and reflects a reflecting light beam, the reflecting light beam passes through the beam splitter 12a and is directed to a light sensor 17a for obtaining useful optical signals. Consequently, focus control is needed for controlling the position of the object lens 13a, so that the laser beam goes as above-mentioned with the focus point 14a of the object lens 13a maintained on the reflecting layer 161a of the disk 16a when the disk 16a performs a vertical wobbling, thus beneficial for data retrieval.

As shown in FIG. 2, a closed-loop control system 20a is generally used to perform the focus control. In the closed-loop control system 20a, the feedback signal of the optical head passes through a pre-amp 21a and produces a focus error. Then the focus error is sent to the compensator 22a to determine a compensating control voltage, and the compensating control voltage drives the motor driver 23a in order to move the object lens 13a, so that the laser beam focuses on the disk 16a. Before design of the compensator 22a, a referral focus error level must be determined. The focus error level affects the direct current gain of the compensator 22a. If the focus error level increases, the direct current gain of the compensator 22a decreases; and if the focus error level decreases, the direct current gain increases. That is, the focus error level and the direct current gain of the compensator 22a are in an inverse proportion.

However, the bandwidth and the phase margin of stability of the compensators 22a in different machines are different. The factors to cause the difference include the dynamic characteristics of the focus actuator 15a, and the gain and the focus error level of the motor driver 23a. Further, the focus error level relates to the power rate of the laser diode 11a, the reflectivity of the disk 16a, and the gain of the photo detect integrated circuit (PDIC) and the pre-amp 21a. That is, different machines may have different power rate of the laser diode 11a, and the gain of the PDIC differs; in addition, different disks 16a may have different reflectivity, which influence the focus error; further, different pre-amps 21a with the same input signal and setup value result in different output. Consequently, it is necessary to adjust these factors to obtain the same focus error input to the compensator 22a. Generally, it is preferred to adjust the gain of the pre-amp 21a.

Conventionally, the S-curve search method is generally applied for adjusting the focus error level, in which the result may be used as a basis for adjusting the pre-amp 21a. In the operation of the method, the focus actuator 15a moves the object lens 13a to sink to the bottom, and moves the object lens 13a toward the direction of the disk 16a ; if the focus point 14a passes the reflecting layer 161a of the disk 16a in a certain distance, the focus actuator 15a moves the object lens 13a in the opposite direction. Repeat the above-mentioned operation for adjusting the focus error level, and a waveform diagram is obtained, as shown in FIG. 3. FIG. 3 shows the corresponding focus error of the object lens 13a with three times S-curse search method, wherein FE denotes the focus error, and FOSO denotes the control output of the focus actuator 15a. However, the conventional operation mentioned above requires moving the object lens 13a within a large range, so that a long time cost is unavoidable.

Consequently, the conventional method of adjusting the focus error level has obvious drawbacks and inconvenience in application, which requires further improvement.

### SUMMARY OF THE INVENTION

In view of this, the present invention aims at the problems of the above-mentioned conventional method, and proposes a method of rapidly adjusting optical drive focus error level, which improves the performance significantly.

The object of the present invention is to disclose a method of rapidly adjusting optical drive focus error level, which does not require additional hardware devices, and all adjustment of the focus error level of the present invention executes by the firmware.

The present invention discloses a method of rapidly adjusting optical drive focus error level. In the present invention, the optical drive has an object lens having a focal point, a pre-amp, and a disk contained in the CD-ROM. The method comprises the steps of: selecting a referral focus error level; sinking the object lens to the bottom, and moving the object lens toward a direction of the disk; detecting the focus error level and determining a position of the focal point of the object lens; comparing the focus error level with the referral focus error level for a reference to adjust the pre-amp when the position of the focal point passes through a reflecting layer of the disk; and calculating the gain of the pre-amp to be adjusted, and changing the moving direction of the object lens, then repeating the detecting step when a difference between the focus error level and the referral focus error level is beyond an error tolerance, otherwise stopping moving the object lens.

### BRIEF DESCRIPTION OF THE DRAWINGS

The present invention can be more fully understood by reading the subsequent detailed description in conjunction with the examples and references made to the accompanying drawings, wherein:

FIG. 1 is a schematic view of the focus action of the conventional optical head;

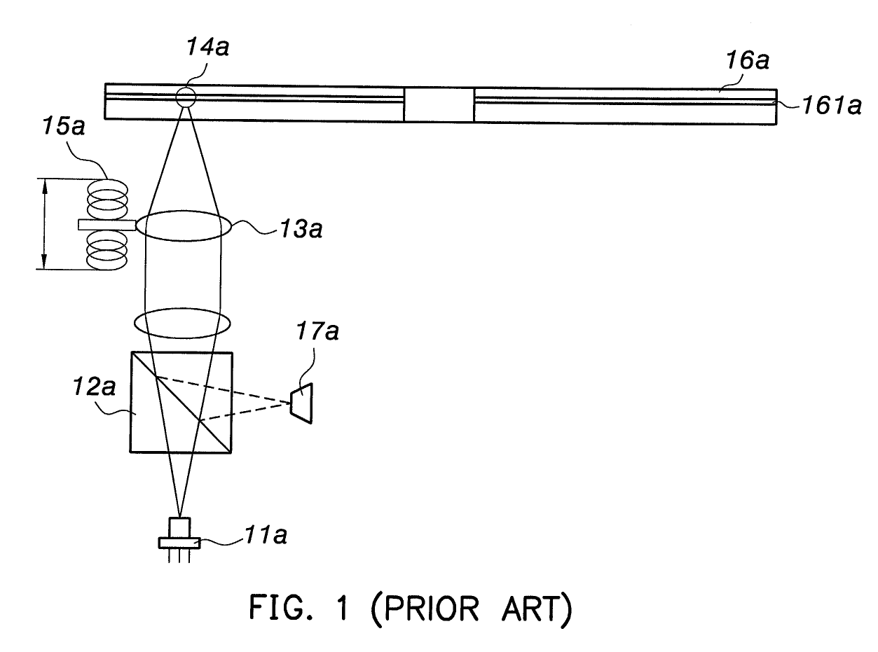

FIG. 2 is a block diagram of the circuit of the convention closed-loop control system;

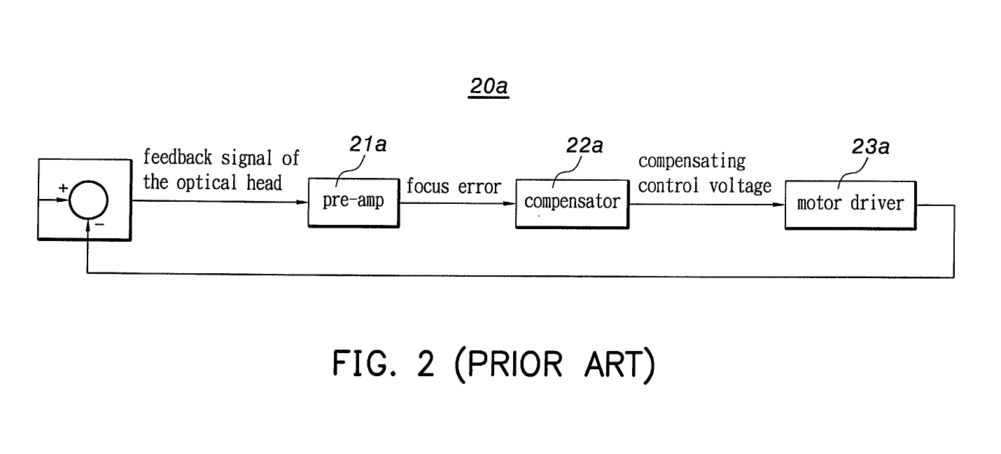

FIG. 3 is a waveform diagram of the conventional focus error adjusting method by the S-curve search;

FIG. 4 is a flow chart showing adjustment of the present invention; and

FIG. 5 is a waveform diagram of the focus error adjusting method of the present invention.

### DETAILED DESCRIPTION OF THE PREFERRED EMBODIMENT

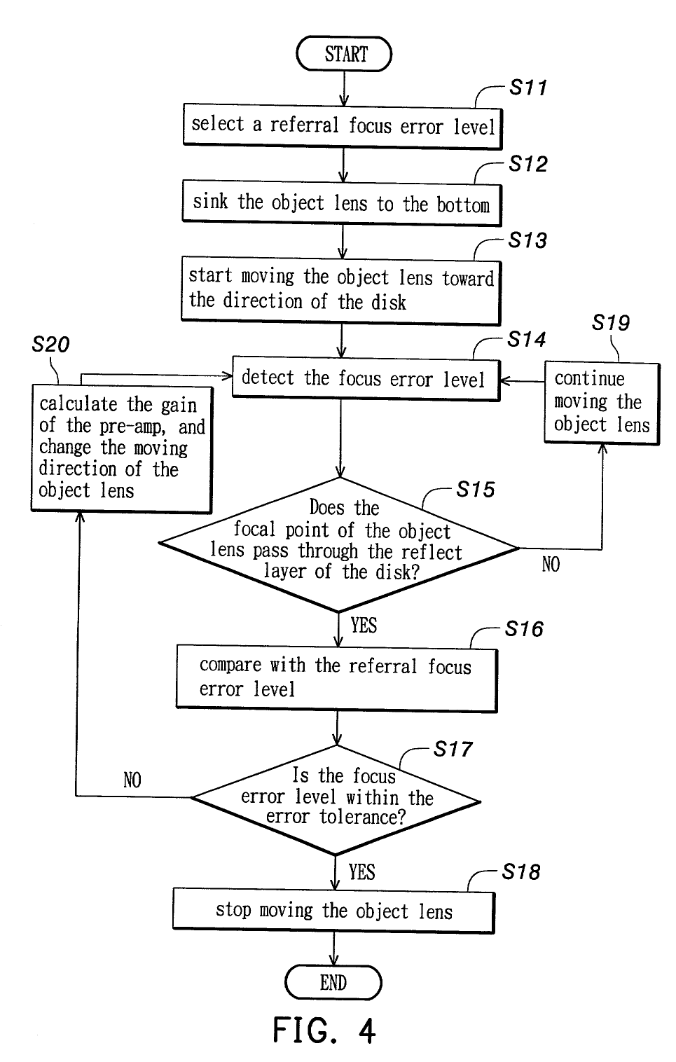

FIG. 4 is a flow chart showing adjustment of the present invention. The present invention discloses a method of rapidly adjusting optical drive focus error level, which comprises the following steps.

Step 11: select a referral focus error level;

Step 12: sink the object lens to the bottom;

Step 13: start moving the object lens toward the direction of the disk;

Step 14: detect the focus error level;

Step 15: Does the focal point of the object lens pass through the reflect layer of the disk?

If yes, go to Step 16. If no, go to Step 19.

Step 19: continue moving the object lens, and go back to Step 14;

Step 16: compare the focus error level with the referral focus error level;

Step 17: Is the focus error level within the error tolerance?

If yes, go to Step 18. If no, go to Step 20.

Step 20: calculate the gain for adjustment of the pre-amp, and change the moving direction of the object lens;

Step 18: stop moving the object lens, turn off the laser diode, and end the adjustment.

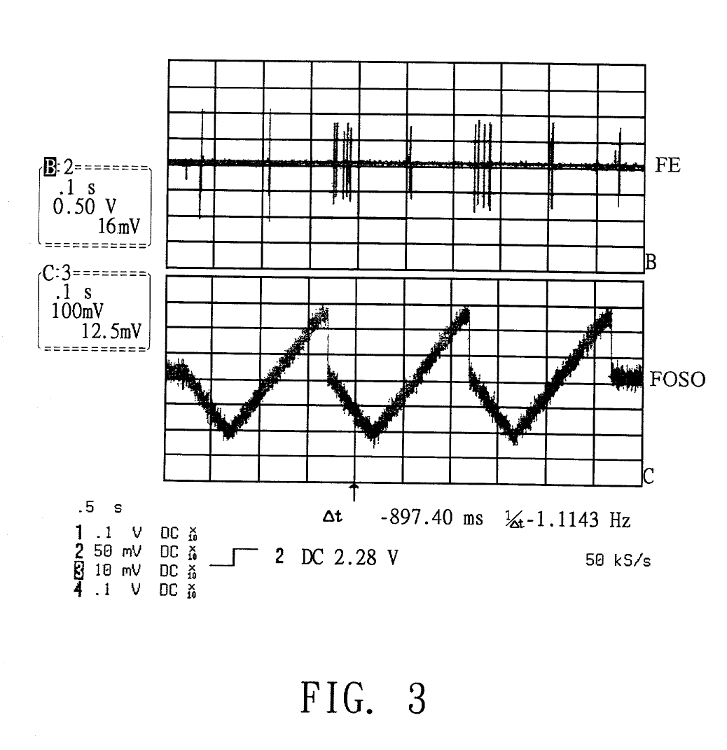

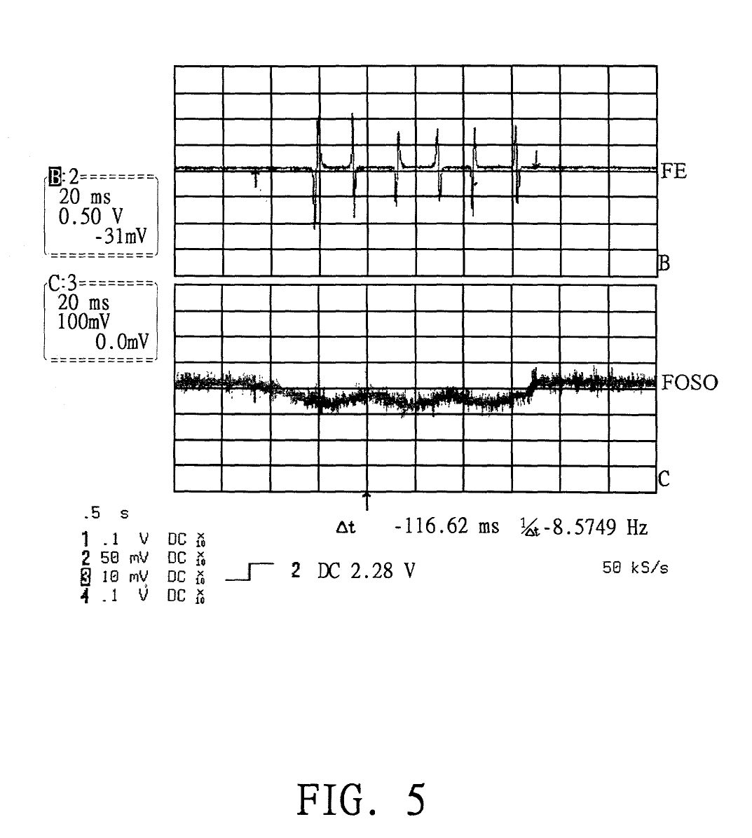

Further, FIG. 5 is a waveform diagram of the focus error adjusting method of the present invention. Compared FIG. 5 to FIG. 3, it is obvious that the time cost of the present invention (the referral focus error level=0.5 V, t=115.62 ms) is about 1/10 of the time cost of the conventional S-curve search method ( t=897.40 ms).

According to this, it is possible for rapidly and efficiently adjusting the focus error level to the referral focus error level, and the effect of the focus error level to the bandwidth and the phase margin of the stability are reduced.

While the present invention has been described with reference to the preferred embodiments thereof, it is to be understood that the invention is not limited to the described embodiments or constructions. On the contrary, the invention is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of rapidly adjusting optical drive focus error level, wherein the CD-ROM comprises an object lens having a focal point, a pre-amp, and a disk contained in the optical drive, the method comprising the steps of:
(a) selecting a referral focus error level;
(b) sinking the object lens to the bottom, and moving the object lens toward a direction of the disk;
(c) detecting the focus error level and determining a position of the focal point of the object lens;
(d) comparing the focus error level with the referral focus error level for a reference to adjust the pre-amp when the position of the focal point passes through a reflecting layer of the disk; and
(e) calculating the gain of the pre-amp to be adjusted, and changing the moving direction of the object lens, then repeating step (c) when a difference between the focus error level and the referral focus error level is beyond an error tolerance, otherwise stopping moving the object lens.
